(19) United States
(12) Patent Application Publication
(10) Pub. No.: US 2005/0207468 A1
(43) Pub. Date: Sep. 22, 2005

(54) Inductively heated transient thermography method and apparatus for the detection of flaws

(76) Inventors: Robert W. McCullough, (US); Phillip D. Bondurant, (US)

Correspondence Address: HAYWARD A. VERDUN, LLP, P.O. BOX 698, CENTERVILLE, LA, 70522, US

(21) Appl. No.: 10/802,121

(22) Filed: Mar. 16, 2004

(51) Int. Cl. G01N 25/72

(52) U.S. Cl. 374/5; 374/57; 374/121

(57) ABSTRACT

A method and apparatus for non-destructive testing of a structure including the deposition of energy volumetrically into an object and detecting transient temperatures at a surface of the object caused by diffusion of the deposited energy. The energy is typically induced within the object by an induction coil and viewed by an IR camera as the transient energy exits the surface of the object.

### BACKGROUND OF THE INVENTION

1. Field of the Invention

The present invention relates to a novel non-destructive testing (NDT) technique and apparatus, and more particularly to NDT technique employing transient thermography.

2. Description of the Related Art

Non-Destructive Testing (NDT) is used to ensure product integrity, product reliability, prevent failure, and ensure operational. Generally, NDT can be divided into two categories, volumetric (those involved with the internal integrity of a structure or part) and surface (those involved with assessment of only the surface of the structure).

One type of NDT is Infrared (IR) transient thermography (IRTT that relies upon temporal measurements of heat transference through an object to provide information concerning the structure and integrity of the object. Conventionally, as described in U.S. Pat. No. 5,711,603 to Ringermacher et al., entitled “Nondestructive Testing: Transient Depth Thermography” the technique involves heating the surface of an object of interest and recording the temperature changes over time of very small regions or “resolution elements” on the surface of the object.

For accurate thermal measurements using IRTT, the surface of a structure or object is heated to a particular temperature in a sufficiently short period of time so as to preclude any significant heating of the remainder of the object. Generally, a quartz lamp or a high intensity flash-lamp is used to generate a heat pulse of the proper magnitude and duration, although any suitable means for quickly heating the surface may be employed.

This method, while an improvement over other NDT techniques still requires the application of heat to the surface of an object or structure and subsequent measure of this transient heat. This approach is time consuming and wastes a lot of energy. Furthermore, the set up of the equipment required to perform a testing, as well as the thickness of the material being tested, often requires a significant amount of time, skill and resources to accomplish the task.

What is needed is a portable, non-destructive and rapid IRTT system that injects energy (such as x-rays, gamma rays, induction heating, electromagnetic) into a volume of the object or structure (i.e. applying the energy near any suspected defect).

### SUMMARY OF THE INVENTION

The present invention has been made in view of the above circumstances and has as an aspect a method for non-destructive testing of a structure wherein energy is deposited within at least a portion of a volume of a structure and transient temperatures are detected at a surface of the structure caused by diffusion of the deposited energy.

A further aspect of the present invention is transient thermography a method for non-destructive testing of a structure wherein energy is deposited within at least a portion of a volume of a structure and transient temperatures are detected at a surface of the structure caused by diffusion of the deposited energy.

A still further aspect of the present invention is a portable IRTT including a tunable induction coil and IR camera capable of interjecting energy volumetrically.

Additional aspects and advantages of the invention will be set forth in part in the description which follows, and in part will be obvious from the description, or may be learned by practice of the invention. The aspects and advantages of the invention will be realized and attained by means of the elements and combinations particularly pointed out in the appended claims.

To achieve these and other advantages and in accordance with the purpose of the present invention, as embodied and broadly described, the present invention can be characterized according to one aspect of the present invention comprises a method for non-destructive testing of a structure wherein energy is deposited within at least a portion of a volume of a structure and transient temperatures are detected at a surface of the structure caused by diffusion of the deposited energy.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 is a schematic diagram of an inductive heating of a honeycomb structure and heat transfer to a surface, of the present invention;

FIG. 2 depicts time sequence data from an IR camera illustrating an inductive heating transient themography technique of the present invention;

FIG. 3 is a chart illustrating skin depth versus frequency of various materials of the present invention;

FIG. 4 depicts a typical Boron/Epoxy skin aluminum honeycomb composite;

FIGS. 5A-5D illustrate flaw types of the honeycomb composite of FIG. 4;

FIG. 6 illustrates a current verse time operating regime for an NDI process;

FIG. 7 illustrates one aspect of a portable scanning system of the present invention;

FIG. 8 illustrates one aspect of a portable hand-held scanning system of the present invention; and

FIG. 9 illustrates a portable head mounted scanning system of the present invention.

### DETAILED DESCRIPTION OF THE INVENTION

Reference will now be made in detail to the present embodiments of the invention, examples of which are illustrated in the accompanying drawings. Wherever possible, the same reference numbers will be used throughout the drawings to refer to the same or like parts (elements).

The basis for the innovative NDI technique lies in the simultaneous combination of three elements: induction heating, transient thermography, and thermal diffusion. In the present invention one embodiment employs induction heating to selectively heat an electrically conductive medium in an assembly, for example a honeycomb adjacent to a boron/epoxy skin. In so doing the present invention is able to heat the material structure close to the layer that contains the flaws to be detected. By selecting a frequency that the conductor responds to the user is able to place the heat source where it will have the most value in the transient thermography system. In addition, the time over which the energy is injected can be tailored by a combination of induced current and exposure time in the case of a pulsed source or velocity in the case of a moving coil. By making the exposure time short with respect to the transient time constant for diffusion perpendicular through the assembly, a clear “picture” of the underlying structure is assured.

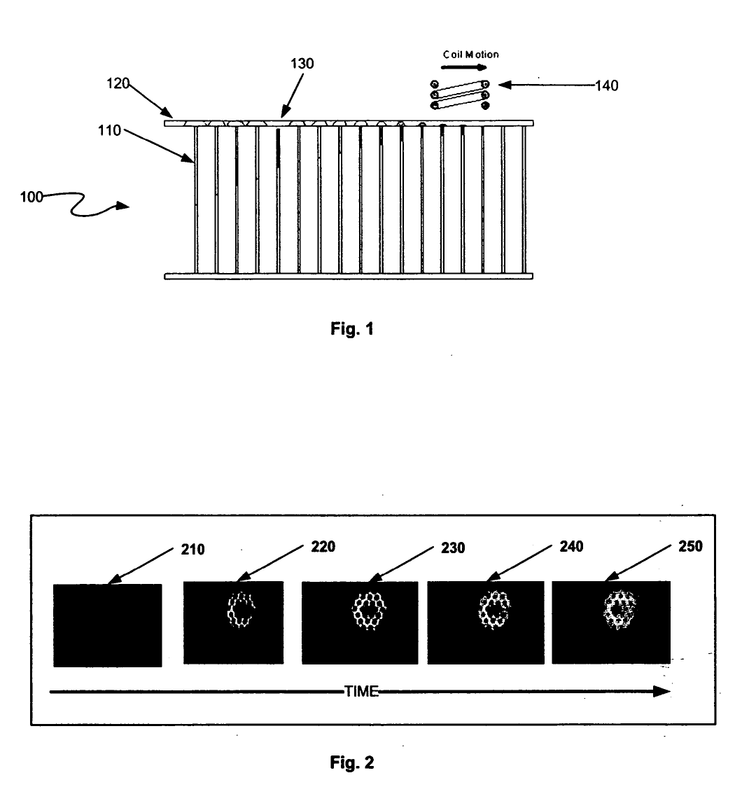

The results of the technique are dramatic. An induction coil moved across the surface of the composite that is being imaged by a sensitive infrared focal plane appears to “light up”. As depicted in FIG. 1, inductive heating of a honeycomb structure 100 for example in a honeycomb assembly 110, a honeycomb shaped pattern forms in about one half second where there is a good thermal path from the honeycomb 110 through skin 120 to the surface. In areas where there is a flaw, for example a disbond or delamination 130 in the skin 110, the amount of thermal energy transported to the surface is lowered giving little or no image. As the heat diffuses laterally, the image appears to blur with the honeycomb pattern gradually washing out to a uniform heat signature. The effect is a transfer of the energy to the skin 120.

The color-coding is of honeycomb 110 represents temperature with red representing the highest and blue representing the least rise above ambient. First the energy is deposited in the ends of the honeycomb in a length that is proportional to the skin depth, in this embodiment approximately the skin depth. For a fixed coil 140 translation speed, a constant amount of energy is left in each honeycomb. As this thermal energy diffuses down the length of the honeycomb 110 and into the skin 120, the average temperature decreases. The energy in the skin 120 diffuses in two directions with a correspondingly more rapid fall-off in temperature. Eventually, the diffusion front reaches the surface where it is detectable by a sensitive IR camera. Note that where there is a disbond flaw 130 energy cannot flow and the only route for the honeycomb tip to lose its energy is down the length. A person of ordinary skill in the art will appreciate that the illustration depicted in FIG. 1 is highly schematic and in reality, there would be a continuous distribution of temperature—not uniform temperatures in each small region.

Because infrared cameras are very sensitive and can easily detect temperature changes of less than one fiftieth of a degree, it takes very little energy injected into the material to make the disbonds visible. Because the energy is injected directly under the region to be inspected, the technique is very specific.

FIG. 2 depicts several frames from a video clip 210, 220, 230 240 and 250 of a machined flaw that simulates a disbond. In this figure, time progresses from left to right. The disbond flaw 130 and several of the effects discussed above are apparent.

Unlike conventional transient thermography where the energy has to diffuse a long distance before detection, the energy in the present invention only has to diffuse the minimum distance between the flaw and the surface. Conventional backlit transient thermography techniques require the energy to pass through two bond interfaces and two skins before reaching the outer surface. Gaps in the conduction path are ambiguous and could be caused by flaws at either end. Because the energy is deposited directly under the region of interest, in the present invention there is little ambiguity.

The speed of the technique is remarkable. In tests conducted a technician with an induction coil wand of approximately 100 mm in diameter can stimulate a honeycomb panel 300 mm by 500 mm in under 10 seconds. The speed is limited mostly by the scan speed of the IR camera over the surface. A high-resolution camera that can view the entire surface can record the results directly. Using this technique it is estimated that a single side of one F-15 vertical stabilizer could be scanned in approximately 15 minutes. Of course, in practice, repositioning the equipment would increase the inspection time but it is easy to imagine a system that could inspect both sides of the stabilizer in less than two hours using a single inspector in a “cherry picker” platform, as shown in FIG. 8.

This speed of scanning an object or structure gives the technique of the present invention a tremendous advantage over ultrasonic or laser interferometric techniques that require the precise and time consuming scanning of a beam of sound waves or coherent light across the surface. This technique has the potential for inspecting a wide variety of structures due to the range of parameters available to work with. By understanding the relative time constants and RF frequency response of the material, combination of parameters to enable the technique to work for many different material combinations can be selected.

An overview of the basic concepts of the present invention regarding induction heating, transient thermography and thermal diffusion will now be discussed below.

Induction Heating

Induction is a fundamental electromagnetic (EM) process in by which a changing magnetic field induces a current in a conductor. Induction is one of the foundations of EM theory and the basis for the operation of electric motors, transformers and many other devices. When conducting materials are formed into coils and time varying current is passed through them, a magnetic field is generated. When this coil is brought close to a conducting medium, a current is induced in the material that attempts to create a magnetic field that just cancels the field created by the coil. The driving coil senses this opposing effect through an effect called mutual inductance, which is the basis for “eddy current” NDI technology, labeled after the type of currents induced in the material. In eddy current NDT, changes in the detected mutual inductance are interpreted to indicate the presence of flaws in the material that disrupt the induced current.

In a perfect conductor the induced currents are completely effective in opposing the induced magnetic field and it does not penetrate into the material. The familiar demonstration of a magnet suspended above a superconductor show this effect. In normal conductors, however, there is a resistance to current flow in the material and the field penetrates into the material. There are two effects from this: First the opposing eddy currents reduce the magnetic field as one moves into the material so that the field and eddy currents decrease exponentially with depth into the material. The current density then varies with distance into the material as:
J=J₀e^{-z/δ}e^{-iz/δ} Equation 1

Where J₀ is the current density at the surface in amps/m² and z is the distance into the medium in m.

The scale length for the exponential decay of field and current, δ, is known as the “skin depth” and is given by the expression:
δ=1/(πμσf)^{1/2} Equation 2

Where σ is the conductivity of the material, f is the frequency and μ is the magnetic permeability.

The second effect from the finite resistance of the material is that there is heat dissipated through ohmic losses. The volumetric rate of heat generation is given by
Q=J²/σ Equation 3

Where J is the current density in amps/m². This heat dissipation is the term on the right hand side of the heat conduction equation and is the basis for our innovation. It can see from the equation for skin depth that by changing the frequency for a given material, the user can change the depth to which heating is induced. This provides a powerful tool for probing a material using transient thermography.

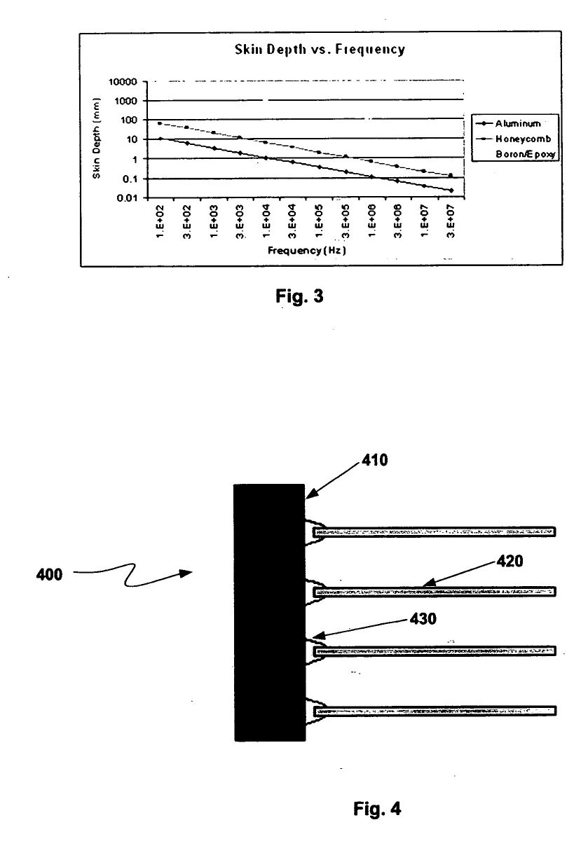

The use of this effect can be clearly seen by considering FIG. 3. FIG. 3 depicts a plot of the skin depth of a solid aluminum sheet, aluminum honeycomb and boron epoxy composite material. The chart of FIG. 3 illustrates that skin depth over a wide frequency range from 100 Hz to 30 MHz can be easily obtained. The process could conceivably employ sources well into the microwave region up to 100 GHz as well. For example, if the skin depth values at a single frequency, say 100 kHz, are examined, it can be seen that the skin depth for solid aluminum plate is about 0.3 mm while that for aluminum honeycomb is about 5 mm and the skin depth for the boron skin is about 300 mm.

Therefore, the field of an induction coil placed above the boron/epoxy-aluminum honeycomb structure similar to the F-15 vertical stabilizer will easily penetrate the skin and will penetrate about 5 mm along the honeycomb. Since the magnitude of induced current is highly dependent upon the conductivity, the skin will have very low current while the aluminum honeycomb will experience an induced current. The magnitude of the induced current is proportional to the magnitude of the current in the stimulating coil so that we can adjust the induction heating to any level by controlling the current in the coil.

Transient Thermography

Transient thermography is a relatively recent NDI technique made possible by the development of sensitive infrared focal plane arrays. These devices are effectively video cameras that “see” in the infrared region of the spectrum where the radiation emanating from a body is composed of emitted radiation as well as reflected radiation. Because the devices are very sensitive, temperature differences as small as 0.020 K can be detected. Infrared cameras are used in NDI in steady state conditions to observe hotspots in electrical equipment, leaky insulation in homes, and industrial plants. Interest here is in the use of these sensitive detectors in observing transient events.

The basic concept behind all transient thermography is to provide an input of energy to the solid by some means and to observe the resulting temperature fields as they respond to the input. Any feature of the material or structure that results in an anomalous value of diffusivity will change or distort the transient temperature field. This technique is especially well adapted to looking for cracks in metallic structures where even a tightly closed crack can cause a substantial change in the transient temperature field. Is it also very useful for detecting voids in materials or gaps in the bond layer in bonded materials. As the sensitivity of IR cameras increases with technology development, the process will become more sensitive and will require less energy to be input. However, even with cameras of lesser sensitivity the process can still be adapted by adjusting the level of energy input.

Because of the nature of the diffusion process, the location of the flaw relative to the excitation means is very important. In diffusion processes the field is dissipative and the amplitude of the variation in the field (temperature in the present invention case) will decrease with distance or time from the stimulation event. This makes detecting flaws deep in a material more difficult than those at the surface in general. This is in contrast to, for example, ultrasonic NDI in which a wave is launched into a material and is reflected by flaws. Most materials are not highly dissipative of ultrasonic energy and the ultrasonic wave propagates to and from the flaw with reasonable reduction in amplitude due to attenuation. Flaws deep within the material can be detected so long as their ability to reflect or scatter the energy is good.

Most previous work on transient thermography has focused on methods that inject heat into the surface of the material by means of radiant energy (e.g. flash lamps or lasers) or convection. In these methods the flux to the surface is applied for a fixed length of time, then removed and the temperature field of either the heated surface of another surface is observed as a transient event. Recent work has used acoustic fields coupled into the surface of a material. In this method the acoustic energy is converted to heat by frictional dissipation. This can occur at the interface between materials with faulty bonds or between the walls of a crack. This technique is especially attractive for NDI because the source of the thermal energy is located in the flaw itself. Unfortunately, efficiently coupling acoustical energy into large areas is not usually practical.

Thermal Diffusion

Heat conduction a solid is described by Fourier's law of heat conduction, which states that the rate of energy conducted through a solid is proportional to the gradient of temperature in that solid. When incorporated into the equation for conservation of energy in a solid the following equation is easily derivable for isotropic solids:
k∇²T−ρc∂T/∂t=Q Equation 4
where k is the thermal conductivity in W/m K, ρ is the density in kg/m^{3,} T is temperature in K, c is the specific heat in J/kg K and Q is the rate of volumetric heat addition in W/m³. This is a classical time dependent diffusion equation, which is more apparent by dividing through by ρc to get:
   α∇²T−∂T/∂t=q Equation 5
where α is the diffusivity in m²/sec and q is the volumetric rate of temperature rise in K/sec. Of course, to completely specify the problem a set of boundary conditions must be defined which specify usually that a boundary is held at a fixed temperature of subject to a given heat flux.

The primary parameter that characterizes diffusion is the thermal diffusivity, α, and values of α for several materials of interest are given in Table 1 below along with values for density, conductivity and heat capacity. Note that diffusivity can vary over several materials with the highest values being in the range of 2 cm²/s and going down to 0.001 cm²/s.

TABLE 1
Thermal Properties of a Few Materials

| | Thermal | Heat | | Thermal |
|---|---|---|---|---|
| | Conductivity | Capacity | Density | Diffusivity |
| Material | (w/m K) | (J/gm K) | (gm/cm³) | (cm²/sec) |
| Aluminum | 237 | .90 | 2.70 | 0.95 |
| Titanium | 21.9 | .52 | 4.54 | 0.093 |
| Copper | 401 | .38 | 8.96 | 1.18 |
| Boron | 27.4 | .60 | 2.34 | 0.20 |
| Epoxy | 1.0 | 1.2 | 1.1 | 0.0076 |
| Boron/Epoxy | 11./16.* | 1.0 | 2.0 | 0.055/0.080 |

*Normal to fiber plane/parallel to fibers

In general, for a body of a material with a size given by the length scale L, a time constant that one would associate with a change in conditions would be given by
τ≈L²/α Equation 6

This relationship is central to understanding the process of transient thermography in that one point of interest in the present invention is the relative time for diffusion processes required to produce measurable temperature changes on a surface. By way of example, if in FIG. 1, the aluminum honeycomb 110 has a wall thickness on the order of 0.1 mm and a width of 50 mm the time for temperature nonuniformity across the wall thickness to level out through diffusion is 0.1 msec, while the time constant for dissipation down the length of the honeycomb cell is 30 sec. For the boron/epoxy skin 120, the thickness is approximately 2 mm and the cell size of the honeycomb is approximately 5 mm. This implies that the time for thermal energy to diffuse through the skin in the normal direction is approximately 0.08 sec while lateral nonuniformities in the skin with scale lengths the size of the honeycomb cell size dissipate is about 3.0 sec.

These numbers indicate the mechanism of our stimulation technique using RF energy. When energy is deposited in the honeycomb material in a region near one skin, the energy in the heated end of the honeycomb takes approximately 30 seconds to leak out the length of the honeycomb. Thermal energy diffuses through the skin wherever the honeycomb is bonded to it about a second. This honeycomb shaped heat pattern on the surface of the skin dissipates laterally in about 3 seconds. Observed temperature of the surface shows a transient temperature pattern in a honeycomb shape wherever there is a good bond. That pattern persists for a few seconds and then dissipates. Flaws are indicated by gaps in the patterns.

Conventional flash lamp heating works, but not very well due to the necessity of the thermal diffusion front to travel from the front or rear surface to the flaw region and then the time for the effects of the flaw to be visible. In addition, because diffusion is a dissipative process, the thermography signal level (i.e. surface temperature) is decreasing continuously during this time. The results are weak and difficult to interpret.

A typical composite structure 400 is shown in FIG. 4. This construction is used on some major aerodynamic surfaces for the F-14 and F-15 fighter aircraft. The skin is made up of several layers of boron fiber layers 410 impregnated with epoxy. The skins depicted are bonded to aluminum honeycomb 420 with epoxy 430 and have a wall thickness of 100 microns.

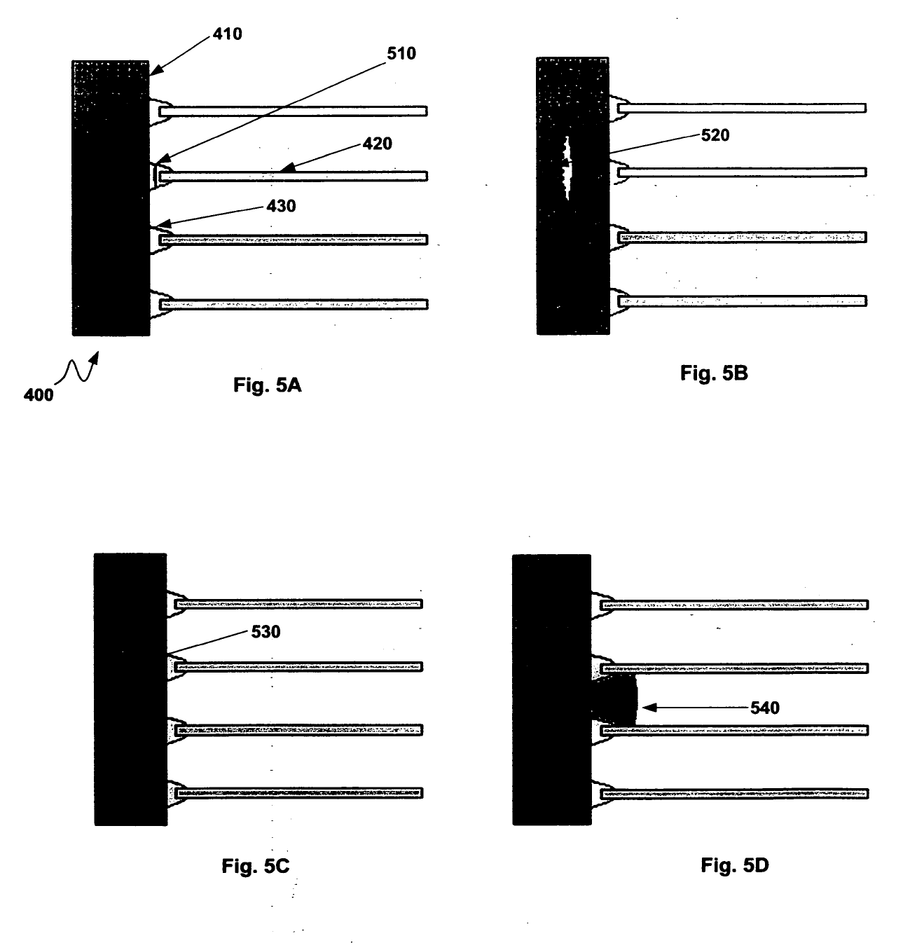

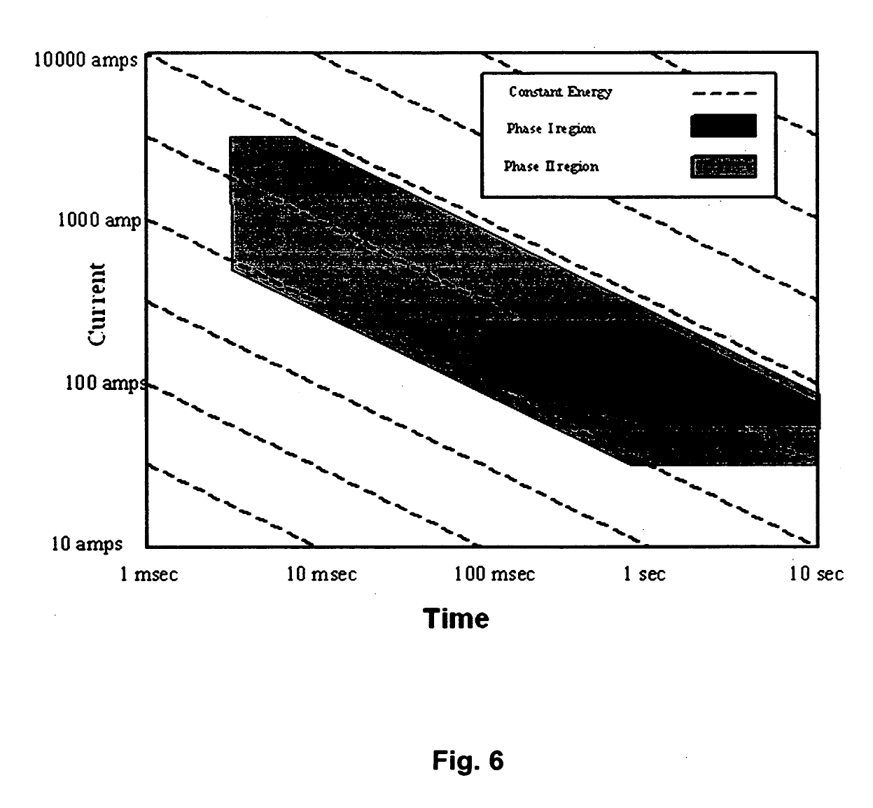

Note that the skin thickness may vary from 2 to 5 mm while the width of the honeycomb can vary from 0 to 100 mm. There are four major categories of flaws that are typically of interest, as shown in FIGS. 5A-5D. They are:
Honeycomb disbond;
Inter-laminar delamination;
Honeycomb water ingress; and
Inter-laminar water ingress.

The first type of flaw, as shown in FIG. 5A, occurs when the honeycomb 430 bond between the skin 410 and honeycomb 420 fails 510 (i.e. honeycomb disband). In this case, the material may be in contact but with no bond strength. Even the smallest air gap in a material failure can cause significant increases in the thermal resistance.

The second type of flaw, as shown in FIG. 5B, occurs when the bond between laminations 520 in the skin fails. These types of flaws are difficult to detect with ultrasonics when the flaw is closed. Again, this type of flaw will present a substantial increase in thermal resistance.

Water ingress 530 into composite panels, as shown in FIG. 5C, presents a significant problem especially for jet aircraft that routinely fly at altitudes where temperatures fall below freezing. Water can accumulate in the lower end of the honeycomb cavity where it can cause corrosion of the honeycomb and a weakening of the honeycomb strength. This condition will be apparent, as the water will have a larger conductivity than the air in adjacent honeycomb cells.

The last type of flaw, as shown in FIG. 5D, is a delamination in the skin into which water has permeated 540. This type of flaw is difficult to detect with ultrasonics but the presence of water will be detectable with transient thermography, especially if a technique can be found that preferentially heats the water.

Parameter Ranges

Frequency of the induction coil is one parameter for tailoring the technique of the present invention to a given material and also the most difficult to change. Adjusting the exposure time is merely a matter of setting a timer on the power supply. Adjusting the current is merely a matter of increasing the power setting on the RF amplifier. The frequency is a delicate balance of a number of factors.

The basic circuit that drives the induction coil is an inductive/capacitive resonant circuit in which the inductor is the primary side of a transformer with the application coil directly coupled to the secondary side. This tank circuit has a natural resonance frequency that depends upon the values of inductance and capacitance in the tank. When the inductance coil is brought into the vicinity of the test specimen the induced eddy currents appear as a complex load on the circuit containing both an inductive (reactive) and resistive component. This causes the resonance frequency to shift and the RF driver circuitry must shift to maintain efficient operation. An additional complexity arises because RF power supplies typically like to see an impedance of about 50 ohms. To achieve this, the primary side of the transformer is tapped near one end of the turns coil and coupled to the RF supply through an additional LC tunable circuit to reduce the amount of power reflected back into the RF power supply. The net result is that a series of high volt-amp rated capacitors, along with an assortment of inductive transformers, are required to cover a wide frequency range.

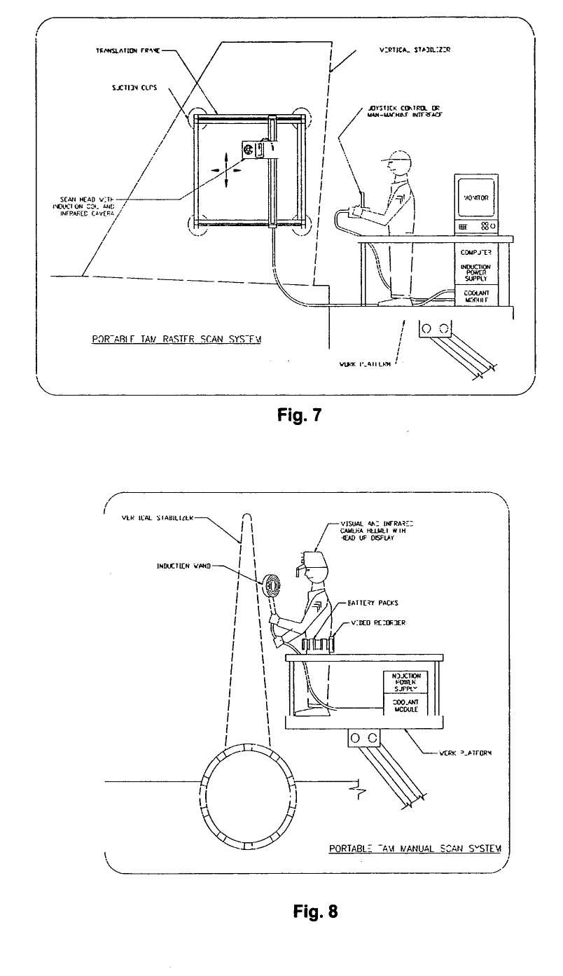

There are many possible embodiments of the system. Two in particular are shown in FIG. 7 and FIG. 1. In FIG. 8 the system consists of a scan unit mounted to a structure such as a vertical stabilizer with suction cups. The unit scans the induction coil over a section of the surface. An IR camera mounted just beside the coil to record images just downstream of the coil during the scan. An alternative embodiment places the scan unit contain the only induction coil while the IR camera records the image from a fixed mount. The induction heating in either case may be continuous or incremental. The X-Y position of the camera location would be recorded on the videotape of the inspection. Image processing software categorizes detected flaws. Systems with multiple cameras and inductive heating coils are also within the scope of the present invention.

An alternate embodiment of the present invention is depicted in FIG. 8. In this embodiment the operator scans the Induction coil in the form of a wand. The IR camera is mounted on his head along with a head mounted display. Under this option the operator would be placed near the stabilizer in a cherry picker or scaffold and would scan the surface of the stabilizer manually. A second visible camera could be mounted on his headgear to record the position accurately.

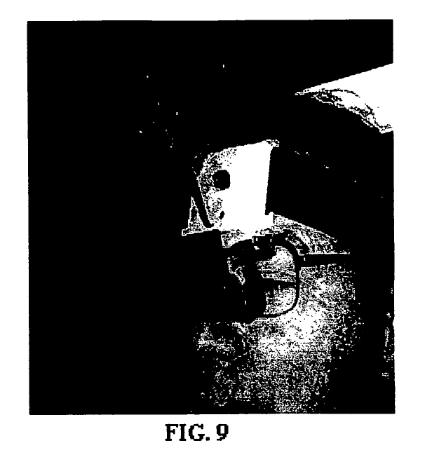

In a further embodiment, as shown in FIG. 9 an operator would wear the IR camera with a head mounted display and manually sweep the RF wand over the surface. This arrangement allows for a high level of interaction by the operator and enables the operator to examine questionable spots more carefully. The head mounted display allows viewing the scene normally in addition to through the camera. A second camera for imaging in the visible spectrum and bore sighted can be employed in an alternate embodiment of the present invention, wherein the resulting video stream is recorded perhaps with a narration on a digital video recorder.

This aspect of the invention can provide for a recorded history of the scanning to ensure quality control and as to provide for a later viewing of questionable areas.

This aspect also provides for multiple cameras of the IR spectrum, visible spectrum or ultraviolet spectrum, depending on the application, to augment or validate the scanning process.

The use of composites in aviation is widespread. In addition to boron/epoxy skins that were the focus of the proposed activity, the present invention is capable of being employed on a variety of other composite skins including carbon/epoxy, graphite/epoxy, Kevlar/epoxy, and glass/epoxy materials in a wide range of industries, such as, but not limited too, aviation, military applications, automotive industry, etc. While graphite and carbon materials do have conductivity greater than boron, their values are still orders of magnitudes lower than aluminum or titanium. Therefore, a frequency for stimulation can be selected which will penetrate the skin to the conducting under layer. In addition to composite skins, many aircraft have special coatings designed to camouflage or provide radar properties.

In addition to detecting disbond and delaminations, the present invention is capable of locating conducting elements in a composite lay-up. Threaded inserts can be located from the opposite surface that may be more accessible, for example. Composite structures such as turbo fans or helicopter rotors are also prime candidates for inspection using our technique.

Although boron/epoxy structures are principally used only for repairs in the commercial aircraft arena, the use of other composites is wide spread. For instance, Boeing® uses Kevlar®/epoxy and carbon/epoxy structures in the airplane manufacturing for the 757, 767, and 777 which have extensive composite elements. Also the new versions of the 737 have been redesigned with composite panels.

Many aerospace structures employ composite structures to save weight or control thermal loads. This technique will be very valuable for inspecting bonded structures consisting of insulation over metal. Two obvious applications are for the Space Shuttle in testing the bonding of the sprayed isocyanurate like foam insulation on the external H2/O2 tank and in testing the bonding of the ceramic tiles to the shuttle skin. Because both of these structures involve electrically insulating layers bonded to conducting sub structures, they are ideal candidates. In addition, many space structures consist of composite booms or joists attached to metal end fittings.

A particularly good application in the area of space vehicles is in the inspection of the insulating layer between the propellant and motor case for solid rocket motors. In many cases, the outer case is aluminum alloy (Space Shuttle SRM and Minuteman III are two common examples). The insulating layer that is applied to the motor case must maintain a good bond. Failure of the bond allows hot combustion gases to ingress and flow adjacent to the metal wall potentially melting the case and causing catastrophic damage. This technique could be applied by passing a coil over the exterior of the case and observing the interior or exterior of the motor with the IR camera.

In the automotive industry composites are being widely adopted for body panels and frame components. A series of QC tools based on the present invention technique could be used to assure the integrity of the bonding and attachment points. Additional application in monitoring coatings integrity also exist. In addition to coatings and composite body panels, there may be an application in QC tests for castings such as engine blocks and engine heads. Advanced building materials often rely on a composite structure consisting of an insulating layer over a metallic substrate. Application for QC in production may be of interest here. In addition, the system will be useful in locating metallic fasteners below the surface including these composed of non-ferrous materials.

A person of ordinary skill in the art will appreciate that the present invention can be modified to incorporate multiple energy sources and types and still come within the scope of the present invention. For instance in an alternate embodiment, the energy deposited can be one of a dielectric heating, induction heating or penetrating radiation x-rays or gamma rays). Also a direct current (DC) can be applied, depending on the application and circumstances, to a portion of the object and the transient energy view by the IR camera.

Additionally, multiple IR cameras and induction coils and be employed in the current invention, in combination with a scan or as individual scans of the same unit. For instance, in the present invention multiple users can simultaneously scan a large object, such as an F-16 wing without interfering with other users similarly engaged in the scanning of the object.

It will be apparent to those skilled in the art that various modifications and variations can be made in the An Inductively Heated Transient Thermography Method And Apparatus For The Detection Of Flaws of the present invention and in construction of this invention without departing from the scope or intent of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for non-destructive testing of a structure, the method comprising the steps of:
depositing energy within at least a portion of a volume of a structure; and
detecting transient temperatures at a surface of the structure caused by diffusion of the deposited energy.

2. The method for non-destructive testing according to claim 1, further including the step of automatically analyzing the detected transient temperatures.

3. The method for non-destructive testing according to claim 2, further including the step of automatically analyzing the detected transient temperatures by a computer processor.

4. The method for non-destructive testing according to claim 2, further including the step of determining whether a flaw is present in the structure.

5. The method for non-destructive testing according to claim 4, further including the step of recording a location of one or more detected flaws in a structure.

6. The method for non-destructive testing according to claim 5, further including the step of providing a user with at least one of an auditory or visual indication when a flaw is detected.

7. The method for non-destructive testing according to claim 1, wherein the transient temperatures are detected by one or more IR focal plane arrays.

8. The method for non-destructive testing according to claim 7, wherein the IR focal plane array is an IR camera.

9. The method for non-destructive testing according to claim 8, wherein the IR camera is an IR video camera.

10. The method for non-destructive testing according to claim 1, wherein the deposited energy is at least one of dielectric heating, induction heating or penetration radiation.

11. The method for non-destructive testing according to claim 10, wherein the penetration radiation is at least one of gamma rays or x-rays.

12. The method for non-destructive testing according to claim 1, further including the step of varying frequency of the deposited energy to produce a resonating effect within the structure.

13. The method for nondestructive testing according to claim 1, wherein the energy deposited includes multiple energy frequencies.

14. The method for non-destructive testing according to claim 1, wherein the structure is at least one of a metal, composite metal, carbon fiber, ceramics or fiberglass.

15. The method for non-destructive testing according to claim 1, wherein the structure is comprised of a metallic portion and a non-metallic portion.

16. The method for non-destructive testing according to claim 1, wherein the structure is comprised of at least two thermally dissimilar metals.

17. The method for non-destructive testing according to claim 15, wherein the structure is comprised of a metal, a boron-epoxy skin and a honeycomb panel.

18. The method for non-destructive testing according to claim 1, wherein the diffusion of the deposited energy forms a pattern.

19. The method for non-destructive testing according to claim 18, wherein the pattern has a honeycomb shape.

20. The method for non-destructive testing according to claim 19, wherein the structure is and airplane wing.

21. The method for non-destructive testing according to claim 20, wherein the airplane wing is an F-15 airplane wing.

22. An apparatus for non-destructive testing of an object, the apparatus comprising:
An induction coil capable of injecting energy volumetrically into at least a portion of an object;
an IR camera for viewing transient heat generated by the energy introduced into the object by the induction coil as the heat exits a surface of the object.

23. The apparatus for non-destructive testing according to claim 22, wherein the apparatus is portable.

24. The apparatus for non-destructive testing according to claim 22, wherein the apparatus can be mounted on a users head.

25. The method for non-destructive testing according to claim 22, wherein the deposited energy is at least one of dielectric heating, induction heating or penetrating radiation.

26. The method for non-destructive testing according to claim 25, wherein the penetrating radiation is at least one of gamma rays or x-rays.

27. The method for non-destructive testing according to claim 22, wherein frequency of the deposited energy to produce a resonating effect within the object can be varied.

28. The method for non-destructive testing according to claim 22, wherein the energy deposited is a direct current and is applied to at least a portion of the surface of the object.

29. A method for non-destructive testing of a structure, the method comprising the steps of:
applying a DC current to at least a portion of a volume of a structure; and
detecting transient temperatures at a surface of the structure caused by diffusion of the deposited energy.

30. A method for non-destructive testing of a structure, the method comprising the steps of:
means for injecting energy within at least a portion of a volume of a structure; and
means for monitoring temperatures at a surface of the structure caused by diffusion of the deposited energy.

31. The method for non-destructive testing according to claim 30, further including means for analyzing the monitored temperatures.

32. The method for non-destructive testing according to claim 31, further including means for analyzing the monitored temperatures by a computer processor.

33. The method for non-destructive testing according to claim 30, further including means for determining whether a flaw is present in the structure.
